(19) United States
(12) Patent Application Publication
(10) Pub. No.: US 2008/0275786 A1
(43) Pub. Date: Nov. 6, 2008

(54) SYSTEM AND METHOD FOR INCREASING PURCHASE CONVERSION RATES

(75) Inventor: ADRIAN GLUCK, Beverly Hills, CA (US)

Correspondence Address: BARLOW, JOSEPHS & HOLMES, LTD., 101 DYER STREET, 5TH FLOOR, PROVIDENCE, RI, 02903, US

(73) Assignee: DIGITAL INTERACTIVE SYSTEMS CORPORATION, Long Beach, CA (US)

(21) Appl. No.: 12/114,996

(22) Filed: May 5, 2008

Related U.S. Application Data
(60) Provisional application No. 60/915,723, filed on May 3, 2007.

(51) Int. Cl. G06Q 30/00

(52) U.S. Cl. 705/14

(57) ABSTRACT

A system and method is provided for increasing purchase conversion rates for prospective online buyers of products and services by offering an incentive to encourage a quicker decision to complete the purchase. In those cases when a trial is offered, the present invention incentivizes the prospective buyer to skip the trial and proceed immediately to purchase the product or service being offered. The system includes a timer that is visible to the customer and counts the elapsed time since the offer was made and an offer statement that describes the incentive being offered in order to proceed with the purchase. The timer in turn counts down a time until the incentive offer expires. There may further be a hidden prize offered by the seller, to be won by the potential purchaser if they make the decision to buy at a specific time during the offer period.

### CROSS-REFERENCE TO RELATED APPLICATIONS

This application is related to and claims priority from earlier filed U.S. Provisional Patent Application No. 60/915,723, filed May 3, 2007.

### BACKGROUND OF THE INVENTION

The present invention relates generally to a method and system for increasing the rate at which a customer completes an online purchase. More specifically, the present invention relates to a method and system for increasing purchase conversion rates for prospective online buyers of products and services by providing them with a time limited incentive that encourages them to make a quicker decision to complete the purchase. Further, in those cases when a trial is offered, the present invention incentivizes the prospective buyer to skip the trial and proceed immediately to completing the purchase of the product or service being offered.

A wide variety of products and services are now offered for sale via online channels such as through Internet websites. A person searching the Internet can find virtually any product or service that suits nearly all of their needs. The difficulty is that since the consumer can easily locate the products for which they are searching, the consumer gets into the mind set that there is no immediacy to their need to complete a purchase since they can always go back at a later date to complete the purchase. However, this behavior can result in the loss of sales because a large percentage of consumer sales are based upon the impulse purchasing phenomenon, wherein a consumer decides on the spur of the moment that they desire an item and makes the purchase immediately. Should a consumer leave the current website it is likely that the purchase impulse may pass before their return. Additionally, it is possible that the consumer will simply make the purchase at the next available retailer site that carries the product.

A further difficulty that arises in the online purchasing environment comes about because the online shopping model is based on the fact that the retailer must ship the purchased items to the consumer via a paid carrier, such as United Parcel Service, Federal Express and the like. In such systems, the purchased items will typically take at least a day, and usually longer, to be delivered to the consumer. This lag presents an added challenge in motivating impulse purchases in the online environment because it is simply more difficult to motivate consumers to make impulse purchases when they will not be able to immediately enjoy the items that they purchased.

In the area of software and video games, such products are available for purchase and immediate download in an online environment thereby overcoming the shipping lag described above. In this regard, there are many well-known systems and methods in the art for purchasing video games online that have been available and in common use for years. Typically, these systems and methods for making an online purchase of video games also include an option for the prospective buyer to try out a video game, listen to a song, or view a video before purchasing.

The main problem that arises with systems and methods that provide a trial is that there is no incentive for users to speed up their trial period and to proceed in purchasing the products. This is because as along as the customer has a free functioning version of the product, they are unlikely to make the actual purchase until the demonstration period has come to an end.

Another problem with conventional systems and methods for purchasing video games online is that there is no incentive to skip the trial step altogether and proceed directly to purchasing the product.

One of the prior art methods employed in attempt to overcome the difficulties discussed above is the promotion of impulse purchasing on the Internet is through the use of incentives. Such incentives, may be in the in the form of a discount or bonus award for purchasing the product and/or service. For example, one form of discount that has been widely used as a purchasing incentive is a discount coupon in electronic or paper form. Electronic coupons are conventionally sent by electronic mail to a consumer, while paper coupons are conventionally provided to consumers through a periodical or via a traditional paper. For redemption purposes, these coupons typically include an electronic code thereon that allows their use in connection with online purchases. In order to redeem the coupon for a product or service and gain benefit of the discount, the code is entered by the consumer in a discount code entry field located on a checkout area of a participating online retailer. The value of the coupon is then applied to the consumer's total to discount the amount that he or she is charged.

Similarly, US Published Patent Application No. 2002/0004742 (Willcocks) discloses an incentive that is presented in an online retail environment wherein the incentive is displayed alongside the purchase price for the goods and services. As time passes, the value of the incentive decreases until the incentive ultimately expires. The problem with such a system is that virtually every purchaser will pay a different price for the goods depending on when in the declining incentive period they execute their purchase. In addition, the timing of the decrease is apparently unknown to the purchaser, adding an element of uncertainty to the buying process. Such an arrangement makes the Willcocks system difficult for the purchaser to understand and difficult for the seller to administer.

Accordingly, while these systems and methods may be suitable for the particular purpose to which they address, they are either too complicated or difficult to administer in a manner that would make them suitable for prospective online buyers of products and services to be given an incentive to make a quicker decision to buy. Further, they do not provide a solution for those cases when a trial is offered in order to incentivize the prospective buyer to skip the trial and proceed immediately to purchase the product or service being offered.

There is therefore a need for a method and system that increases the rate at which a customer makes a decision to complete an online purchase. There is a further need for a method and system for increasing purchase conversion rates for prospective online buyers of products and services by providing them with a time limited incentive that encourages them to make a quicker decision to complete the purchase. There is still a further need, in those cases when a trial is offered, to incentivize the prospective buyer to skip the trial and proceed immediately to completing the purchase of the product or service being offered.

### BRIEF SUMMARY OF THE INVENTION

In this regard, the present invention provides a method and system for increasing the rate at which a customer makes the decision to complete an online purchase. More specifically, the present invention provides a method and system for increasing purchase conversion rates for prospective online buyers of products and services by providing them with a time limited incentive that encourages them to make a quicker decision to complete the purchase. Additionally, in those cases when a product trial period is offered, the present invention provides a method and system that incentivizes the prospective buyer to skip the trial and proceed immediately to completing the purchase of the product or service being offered. Generally, the method and system of the present invention, as will be described below in greater detail, provides for an increase in online purchase conversion rates that includes all of the advantages of the prior art systems and methods for completing an online purchase, such as for example an online purchase of a video game, while also including novel features that result in a new system and method for increasing purchase conversion rates which is not anticipated, rendered obvious, suggested, or even implied by any of the prior art systems and methods for online purchasing, either alone or in any combination thereof.

Generally, the system of the present invention employs a timer system that is visible to the buyer that counts an elapsed period of time starting from the time that an offer for sale of the online goods is made. In addition, the system provides a customer with a statement or a link to an offer statement that describes an incentive that is currently being offered should the customer proceed with the purchase. The offer statement describes what the incentive offer is, the terms and conditions of the incentive offer and at least one of a period of time during which the offer is valid. After presenting the customer with the incentive offer, the customer is advised that the incentive is time sensitive and will lapse after a fixed period of time passes. In this regard, the purpose of the time clock is to count, in real time, the time elapsed since the offer was made thereby giving the customer a visual indication of the time remaining until the incentive offer expires. The time may be expressed in split seconds, seconds, minutes, hours, days, weeks, months and even years.

In addition to the above operation, the present invention may also include an optional component that provides the potential customer with a reminder that the offer is still outstanding and optionally how much time is remaining until the offer expires. For example, if the customer wanders away from the incentivized product, a pop-up window might appear to remind the customer of the pending incentive for the previously viewed product.

Further, there may be a hidden prize that is offered by the seller and is won by the potential customers if they make the decision to buy at a specific time during the offer period. The provided prize is preferably offered by the seller in addition to the incentive offer described in the offer statement.

It is therefore an object of the present invention to provide a method and system for increasing purchase conversion rates related to online purchases that will overcome the shortcomings of the prior art systems. It is another object of the present invention to provide a method and system for increasing purchase conversion rates for prospective online buyers of products and services by providing them with a time limited incentive that encourages them to make a quicker decision to complete the purchase. It is still a further object of the present invention, in those cases when a trial is offered, to incentivize the prospective buyer to skip the trial and proceed immediately to completing the purchase of the product or service being offered. Yet another object of the present invention is to provide a method and system for increasing purchase conversion rates that incentivizes prospective buyers to complete a purchase without first trying out the product, thus reducing the probability of changing their mind before purchasing the product.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a flow chart depicting a first embodiment method for increasing the rate at which a customer completes an online purchase in accordance with the teachings of the present invention;

FIG. 2 is a flow chart depicting a second alternate embodiment method for increasing the rate at which a customer completes an online purchase in accordance with the teachings of the present invention;

FIG. 3 is an illustrative view depicting a first page of the system for increasing the rate at which a customer completes an online purchase;

FIG. 4 is an illustrative view depicting a second page of the system for increasing the rate at which a customer completes an online purchase wherein the timer is activated; and

FIG. 5 is an illustrative view depicting a third page of the system for increasing the rate at which a customer completes an online purchase wherein the timer is expired.

### DETAILED DESCRIPTION OF THE INVENTION

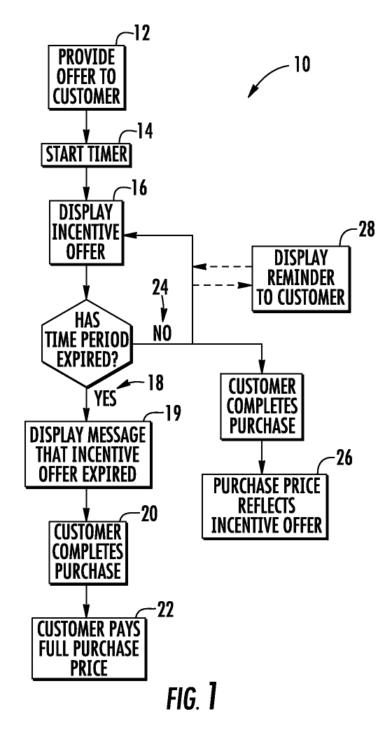

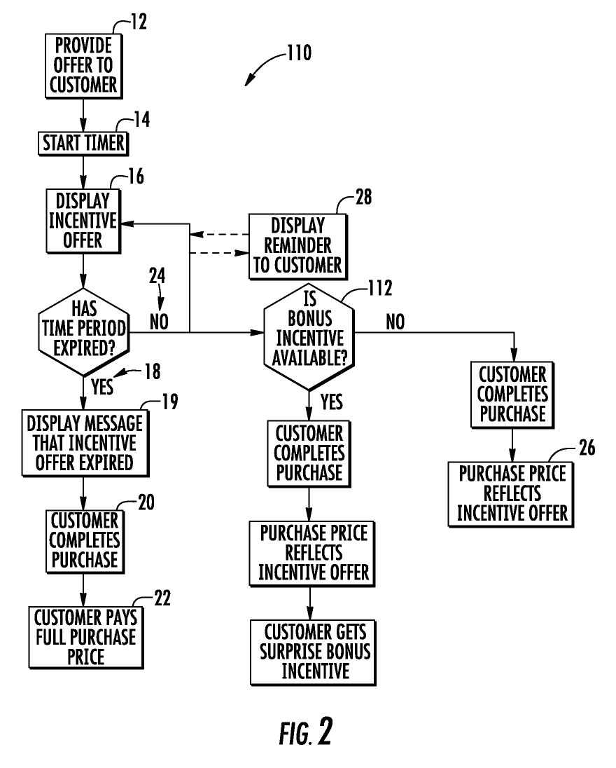

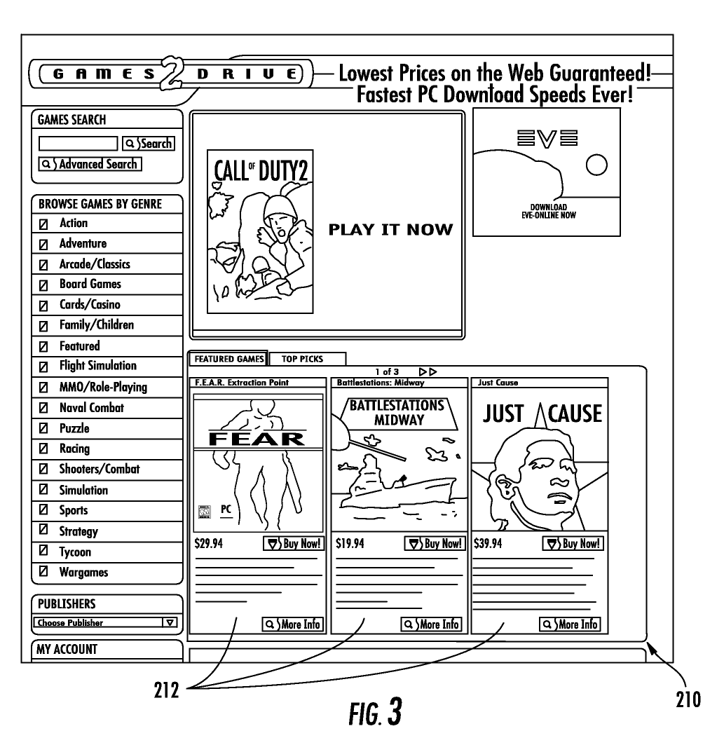

Now referring to the drawings, the method and system for increasing the rate at which a customer makes the decision to complete an online purchase is illustrated graphically wherein in the method is depicted in the flow charts of FIGS. 1 and 2 while the system is generally illustrated at FIGS. 3-5. As was stated above, the present invention provides a method and system for increasing purchase conversion rates for prospective online buyers of products and services by providing them with a time limited incentive that encourages them to make a quicker decision to complete the purchase. Additionally, in those cases when a product trial period is offered, the present invention provides a method and system that incentivizes the prospective buyer to skip the trial and proceed immediately to completing the purchase of the product or service being offered.

Generally, the method 10 of the present invention is designed to increase the rate at which a customer completes an online purchase using the steps of: providing the customer with an offer to make an online purchase for a purchase price 12, providing an incentive offer 16 that is redeemed by the customer when the customer makes the online purchase, the incentive offer 16 being available for a predetermined period of time, and providing a timer 14 that is visible to the customer and that counts the predetermined period of beginning from the time that the customer was provided with the offer 12, wherein the incentive offer 16 expires when the predetermined period passes. In the context of the present invention, the offer 12 made by the retailer to the potential customer is any traditional offer for the sale of goods or services. While the illustrative example provided below is shown in the context of the sale of a video game, the example is provided for illustration only and is in no way intended to limit the scope of the present disclosure. Accordingly, the offer for sale of goods and services 12 is provided to the potential customer and the offer includes a purchase price for those goods and services.

When the offer for sale of goods and services 12 is made to the customer in accordance with the method of the present invention, a timer 14 is started wherein the timer 14 visibly measures a predetermined period of time after the offer for sale 12 is made. In other words, the timer 14 counts, in real time, and displays to the customer the time remaining until an incentive offer 16 expires and/or the time elapsed since the offer for sale 12 was made. The time measured by the timer 14 may be expressed in split seconds, seconds, minutes, hours, days, weeks, months and even years. The timer 14 display can be either in text format or inside the graphic of a clock face. Further, if a clock graphic is used, the timer could be shown either in digital format or in analog format. It should also be appreciated that the timer 14 may count time by either increasing from a starting point, which typically would be zero, or decreasing starting from the predetermined time period thereby indicating the length of time remaining for the incentive offer 16.

In addition to starting a timer 14, an incentive offer 16 statement is also displayed to the potential customer. The incentive offer 16 statement describes the terms and conditions of the incentive offer 16, including at least one of a period of time during which the incentive offer 16 is valid and what incentive is being offered. The incentive being offered in the offer statement may be any type of known incentive typically offered by sellers in order to entice prospective customers to make a purchasing decision and is preferably a percent discount off the regular price, a fixed dollar discount and/or free accessories related to the original product offering.

The method then allows the incentive offer 16 to remain open and available to the potential customer while there is time remaining in the predetermined time period. Upon expiration of the time period 18, the incentive offer expires 16 and the potential customer is notified 19 that the incentive offer is no longer available for redemption. Should the customer make the purchase 20 at this point in time, the customer would simply pay the listed purchase price for the product 22. However, should the customer complete the purchase within the predetermined time period 24 while the incentive offer 16 is still valid, the purchase price for the product will reflect the incentive offer 26 in the form of a reduced purchase price or the like.

In addition to the method detailed above, there may be an optional component that displays a reminder 28 to the potential customer that the incentive an offer is still pending and available. In addition, the reminder may include and display information related to the time remaining until the incentive offer expires. Such a reminder system allows potential customers to carry on with other activities during the incentive offer period while still being informed that an incentive offer is still outstanding. In the most basic form, the reminder indicates at least the fact that an offer is still outstanding. Other indicators may include: actual time remaining until the offer expires, actual time when the offer will expire, ability of the potential customer to set another reminder or to cancel future reminders and an ability for the potential customer to select a mode of being reminded, such as by email, desktop pop-up, text message, telephone, etc.

Turning now to FIG. 2, an alternate embodiment 110 of the method of the present invention is provided. In this embodiment, the method operates in the same manner as described above with respect to FIG. 1 except for an additional feature wherein a hidden bonus incentive 112 is also offered by the seller. In this embodiment, if the potential customer makes the decision to buy at or before a specific time during the incentive offer period, the potential customer will also be awarded the bonus incentive. The bonus incentive 112 may be entirely concealed and therefore a complete surprise to the customer. Optionally, the bonus incentive 112 can be optionally offered and described by the seller in addition to the offer in the offer statement. For example, a bonus incentive 112 may be given a prospective customer decides to buy when there are 10-20 seconds left in the incentive offer period. In this case, if the prospective buyer clicks on a buy button when the timer shows that there are anywhere between 10 and 20 seconds left until the incentive offer 16 expires, the bonus incentive 112 is awarded. The bonus incentive 112 could be described in advance or unknown until it is awarded. Optionally, the customer may be allowed to trade the bonus incentive 112 for an additional discount off the purchase price of the product or service being purchased. Similarly, the bonus incentive 112 may be any type incentive typically offered by sellers in order to enhance the purchasing experience of the buyers including but not limited to another product or service, and add-on or accessory to the product or service being purchased, points towards a future purchase, dollars off a future purchase.

The present invention also provides a system for increasing the rate at which a customer completes an online purchase. The system is generally illustrated at FIGS. 3-5 in the context of an Internet site 210 for purchasing and downloading video games. While the disclosure is depicted in a specific context, it should be understood by one skilled in the art that the example can be easily modified for the sale of virtually any goods or services. The system generally includes an online webpage 210 that provides a customer with an offer to make an online purchase for a purchase price and an incentive offer that is redeemed by the customer when the customer makes the online purchase, the incentive offer being available for a predetermined period of time. A timer is displayed on the online webpage that counts the predetermined period of time, beginning from the time that the customer was provided with the offer, wherein the incentive offer expires when the predetermined period passes.

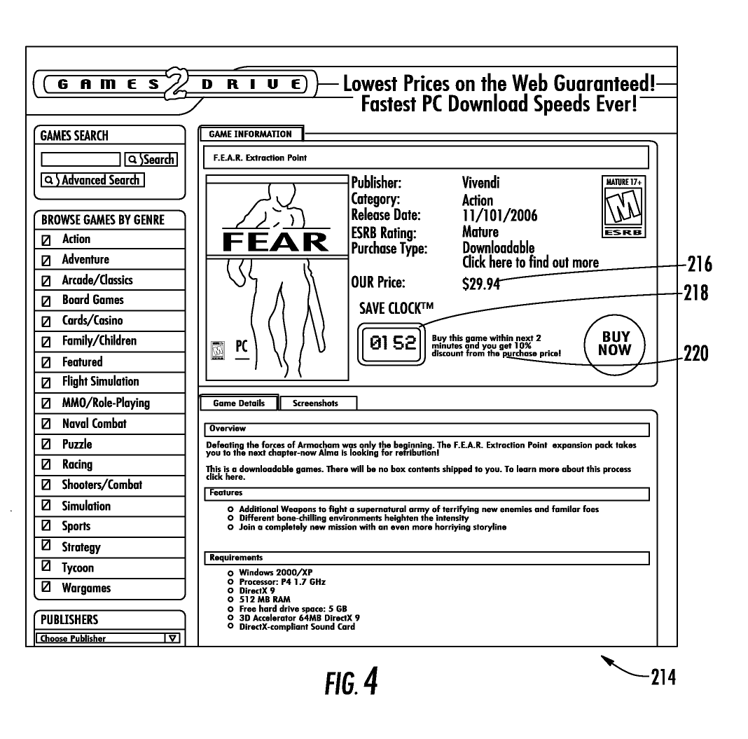

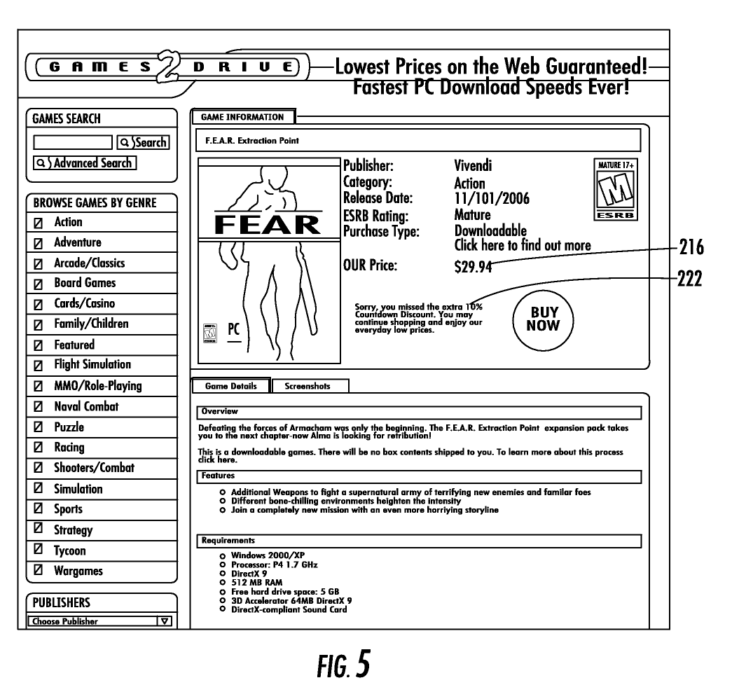

Turning to FIG. 3, in operation, a seller posts a product or service for sale on a website 210. Prospective customers visit the website 210 and browse through the products and services 212 being offered. As they look at an offer posted, such as a picture of a product and its price, or by clicking on a link for “more info”, they are transferred to an offer page 214 such as depicted in FIG. 4. The offer page 214 provides the potential customer with an offer to buy the product or service including a purchase price 216 and further displays a timer 218 together with an incentive offer 220 to obtain an additional bargain. Such an incentive offer 220 may be, for example, a discount off the posted price, provided that the prospective customer completes the purchase decision within a specified period of time. While the prospective customer is deciding whether to go ahead with a purchase, the timer 218 keeps counting the time to the expiration of the incentive offer 220. Upon expiration of the predetermined time, as depicted at FIG. 5, the customer is informed that the predetermined time period has lapsed and that the incentive offer is no longer available 222. At this point the purchase price 216 no longer reflects the incentive offer.

Also, as disclosed above, in addition to the incentive offer, another bonus incentive may be offered, such as a free product, which may only be disclosed after the purchase is completed. Yet another incentive may be offered or hidden in the form of a prize to be won if the buy decision is made at a specific time or during a specific time period unknown to the prospective buyer.

It can therefore be seen that the present invention provides a method and system for increasing purchase conversion rates related to online purchases that will overcome the shortcomings of the prior art systems. Further, the present invention provides a method and system for increasing purchase conversion rates for prospective online buyers of products and services by providing them with a time limited incentive that encourages them to make a quicker decision to complete the purchase and in those cases when a trial is offered, to incentivize the prospective buyer to skip the trial and proceed immediately to completing the purchase of the product or service being offered. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of increasing the rate at which a customer completes an online purchase comprising:
providing the customer with an offer to make an online purchase for a purchase price;
providing an incentive offer that is redeemed by the customer when the customer makes the online purchase, the incentive offer being available for a predetermined period of time; and
providing a timer that is visible to the customer that counts the predetermined period of beginning from the time that the customer was provided with the offer,
wherein the incentive offer expires when the predetermined period passes.

2. The method of claim 1, further comprising:
providing a surprise bonus to the customer if the customer completes the purchase before the predetermined period passes.

3. The method of claim 2, further comprising:
providing the surprise bonus to the customer only if the customer completes the purchase before a fixed portion of the predetermined period passes.

4. The method of claim 2, wherein the surprise bonus is selected from a group consisting of: another product or service, an add-on or accessory for the product or service being purchased, points towards a future purchase and dollars off a future purchase.

5. The method of claim 2, wherein the customer can exchange the surprise bonus for an increase in the value of the incentive offer.

6. The method of claim 1, wherein the incentive offer is a fixed reduction in purchase price that is available only during the predetermined period.

7. The method of claim 1, wherein the incentive offer is selected from the group consisting of: a percentage discount off the purchase price, a fixed dollar discount and an add-on or accessory for the product or service being purchased.

8. The method of claim 1, further comprising:
providing a reminder to the customer.

9. The method of claim 8, wherein the reminder is selected from the group consisting of: desktop pop-up, email, text message and telephone call.

10. A system for increasing the rate at which a customer completes an online purchase comprising:
an online webpage that provides a customer with an offer to make an online purchase for a purchase price and an incentive offer that is redeemed by the customer when the customer makes the online purchase, the incentive offer being available for a predetermined period of time; and
a timer displayed on the online webpage that counts the predetermined period of beginning from the time that the customer was provided with the offer,
wherein the incentive offer expires when the predetermined period passes.

11. The system of claim 10, further comprising:
a surprise bonus offer that is provided to the customer if the customer completes the purchase before the predetermined period passes.

12. The system of claim 11, wherein the surprise bonus is available to the customer only if the customer completes the purchase before a fixed portion of the predetermined period passes.

13. The system of claim 11, wherein the surprise bonus is selected from a group consisting of: another product or service, an add-on or accessory for the product or service being purchased, points towards a future purchase and dollars off a future purchase.

14. The system of claim 11, wherein the customer can exchange the surprise bonus for an increase in the value of the incentive offer.

15. The system of claim 10, wherein the incentive offer is a fixed reduction in purchase price that is available only during the predetermined period.

16. The system of claim 10, wherein the incentive offer is selected from the group consisting of: a percentage discount off the purchase price, a fixed dollar discount and an add-on or accessory for the product or service being purchased.

17. The system of claim 10, further comprising:
providing a reminder to the customer.

18. The system of claim 17, wherein the reminder is selected from the group consisting of: desktop pop-up, email, text message and telephone call.
